(19) United States
(12) Patent Application Publication
(10) Pub. No.: US 2005/0024842 A1
(43) Pub. Date: Feb. 3, 2005

(54) Electronic enclosure and mounting arrangement therefor

(75) Inventor: Andrzej Tadeusz Warenczak, Como (AU)

Correspondence Address: Arnold B. Silverman;Eckert Seamans Cherin & Mellott, LLC, 44th Floor, 600 Grant Street, Pittsburgh, PA, 15219, US

(73) Assignee: Motium Pty Ltd, South Perth (AU)

(21) Appl. No.: 10/855,763

(22) Filed: May 27, 2004

(30) Foreign Application Priority Data
May 30, 2003 (AU) 2003902711

(51) Int. Cl. H02B 1/20

(52) U.S. Cl. 361/826

(57) ABSTRACT

An electronic enclosure (10) adapted to be mounted in an electronics equipment rack (12) wherein the electronics equipment rack (12) is of a predetermined width which is in part defined by the distance between two mounting members (24) which form part of the equipment rack (12). The enclosure (10) is configured to house one or more electronic components which are operatively coupled to provide a specific function. The electronic enclosure (10) comprises two opposing sides (20, 22) which define the width thereof. The width of the electronic enclosure (10) is proportionally smaller than the predetermined width of the electronics equipment rack (12). The electronic enclosure is removably secured to only one of the mounting members (24) of the electronics equipment rack (12) such that an available space (38) is provided alongside the electronic enclosure (10) when it is mounted in the electronics equipment rack (12).

### FIELD OF THE INVENTION

The present invention relates to an electronic enclosure and a means for mounting the electronic enclosure within a standard electronics rack housing. More particularly, the present invention relates to the specific configuration of an electronic enclosure and a means for the mounting thereof which enables a more efficient use of rack space in the rack housing.

In the discussion which follows, the term “electronic enclosure” is used to collectively refer to any computers, computer components, modules, servers, electronic or equipment packages or like components which may typically be retained in a standard electronics rack housing as is well known in the electronics and computing industries.

### BACKGROUND ART

Computers used as servers and related equipment such as disk drive arrays, networking equipment, tape backup drives, power supplies, etc are generally housed in industry standard 19-inch equipment racks. The mechanical dimensions of these racks are well defined and accord to published industry standards, The key aspect of the standard is that a rack requires to be 19-inches wide and allows electronic packages to fit into a cavity within the 19-inch wide rack (ie. with the cavity being 17.75-inches wide).

The equipment rack itself is a relatively simple structure that resembles an open-frame cabinet without shelves. Computer server/component racks are typically constructed with hinged front-doors, rigid sides and a rear panel (which is either hinged or removable, allowing it to be swung out of the way, or removed when access from the rear is desired). Within the “shell” formed by the sides (and the front and rear doors) is a structural frame. The rack frame is capable of supporting the weight of the equipment contained within the rack and serves as the primary means of securing components therein. The rack frame closely resembles an industrial shelving unit and typically includes four rigid corner posts connected to each other with a number of cross members and structural supports. Each of the four corner posts include mounting rails, with holes at regular spacings, which enable the electronic packages to be affixed to the equipment rack, typically with screws.

Equipment racks are designed to house a column of equipment packages that are typically 17.75-inches wide and which may be of varying depths. Whilst the height of an electronic package can vary, to be compatible with the rack mounting structure, it must be an integer multiple of a vertical unit called a “U”. 1U is 44.45 mm (1.75-inches) in height. Equipment packages are thus manufactured in a wide variety of heights, typically being 1U (1.75-inches), 2U (3.50-inches), 3U (5.25-inches), 4U (7.00-inches) and 6U (10.50-inches). The height is directly linked to the function and height requirements of the electronics inside the equipment package. Electronic packages whose height is not an integer multiple of a U can still be used, however, they will not be using vertical space efficiently (ie. they will not be maximising packing density within the equipment rack).

It is however to be noted that an integer multiple of a U represents the maximum height of an equipment package. The actual equipment package is normally slightly shorter than this to aid in the insertion and removal of the package For example, a typical 1U equipment package, being fitted into a 1.75-inch high cavity, will be 1.65-inches high.

Standard 19-inch equipment racks come in a wide variety of heights, the typical maximum height being around 42U. They are also manufactured in a wide variety of depths, typically 600 mm, 750 mm, 900 mm and 1200 mm. A variety of other depths are also manufactured depending on specific application requirements.

Traditionally the equipment package is affixed to the front face of the equipment rack, with on/off buttons, indicator lights and items regularly accessed by users (such as disk drives) accessible at the front face. Power and data connections are typically accessed from the rear of the equipment rack. Various alternative arrangements for mounting different types of equipment enclosures in the rack are also available and include rack shelves, drawer slide arrangements and more elaborate chassis devices.

As the demand for computing power increases, more and more servers are required to be housed in corporate offices. Furthermore, because of the importance of the information stored on servers, servers are often located in dedicated “server rooms”. Many organisations have their servers housed by companies who rent rack space in rooms (or buildings) which provide high levels of physical security, sophisticated fire equipment, very stable and filtered power and very high speed data connections. These “server farm” areas have become particularly important since the proliferation of the world wide web, and most world wide web network servers are housed in such rooms.

It is also noteworthy that physical space for securely locating servers is expensive. In corporate offices there is often limited capacity to expand the server room area. Therefore there is a strong push to continually reduce the volume required by server computers and associated equipment.

To achieve maximum packing density in equipment racks, many companies manufacture server products that are 1U high. Whilst this represents one solution to making efficient use of available space in an equipment rack, there are several deficiencies with such 1U high products. For example, because such enclosures are of a minimum height, there is a limited ability to add expansion cards or the like therein. Also, it is often physically not possible for multiple hard disk drives to be fitted. Furthermore, 1U equipment packages often have cooling problems due to the density of components that are contained within the 1U height restriction. Still further, such 1U servers commonly require equipment racks that are deep so that all the components that need to be fitted into the 1U enclosure can behoused therein.

Similar comments apply in respect of options seeking to further reduce the height of electronic packages that are available. That is, one school of thought is that it is always desirable to make electronics equipment smaller, as this may permit more pieces of equipment to be housed in a standard equipment rack. However, the smallest allowed vertical height of packages in an equipment rack is 1U. A piece of equipment that has a height that is less than 1U must still be mounted so that it occupies 1U. Furthermore, it is not entirely practical to arrange systems to occupy less than 1U of height as devices that are often accessed at the front of the equipment package (such as disk drives) require more height than such an arrangement would allow.

Compact equipment often will not extend the full depth of the equipment rack (eg. it may be 15-inches deep and housed in a standard equipment rack which is 30-inches deep). When components that do not extend the full depth are mounted in a standard rack, space can be wasted and an important benefit of the rack mounting of components is diminished. One way of making use of this wasted space, and increasing the equipment density in the equipment rack is to mount two half-depth equipment packages, one from the front and one from the rear, in a “back-to-back” configuration. This has been tried and has met with limited success, predominantly because the cabling required to power and communicate with the equipment is located on the rear of most electronic packages. In a “back-to-back” configuration, these cables are thus located in the centre of the rack in a location that is generally inaccessible (ie. without removing at least one of the electronic packages). Furthermore, this configuration can make servicing and maintenance extremely difficult.

Whilst one option to increase the packing density of electronic enclosures in a standard equipment rack may be to define a new rack standard, it is evident that this approach is unlikely to be considered favourably. This is particularly so given the large installed base of 19-inch equipment racks and the sheer volume of existing equipment and electronic enclosures designed to fit into this standard mounting arrangement. Many companies have already invested significant amounts of money on their existing facilities and equipment and would no doubt prefer not to have to change their equipment.

As there is a strong push to continually reduce the volume required by server computers and associated equipment, a more desirable alternative may be to create a means to modify the storage capabilities of current equipment racks to allow more storage configurations to be achievable within the confines of a standard “legacy” rack. Such alternatives would ideally be able to work within the existing 19-inch equipment rack standard whilst permitting ease of installation, removal, replacement and interchangeability of the specifically configured electronic enclosures.

With the above challenges in mind, it is an object of the present invention to provide an electronic enclosure and a means for mounting the electronic enclosure within a standard equipment rack that enables a more efficient use of rack space in the equipment rack.

It is a further object of the present invention to enable the packing density of electronic equipment in a standard equipment rack to be increased by providing an array of electronic enclosures across the predetermined width of a standard equipment rack.

### DISCLOSURE OF THE INVENTION

Therefore, there is provided according to the present invention an electronic enclosure adapted to be mounted in an electronics equipment rack, the electronics equipment rack being of a predetermined width which is in part defined by the distance between two mounting members which form part of the equipment rack, the electronic enclosure comprising two opposing sides which define the width thereof, said enclosure being configured to house one or more electronic components which are operatively coupled to provide a specific function, wherein the width of the electronic enclosure is proportionally smaller than the predetermined width of the electronics equipment rack and wherein the electronic enclosure is removably secured to only one of the mounting members of the electronics equipment rack such that an available space is provided alongside the electronic enclosure when it is mounted in the electronics equipment rack.

Preferably, the available space adjacent the electronic enclosure may be occupied by a second electronic enclosure also adapted to be mounted in the electronics equipment rack. The second electronic enclosure is preferably removably secured to the other of the mounting members such that it is located within the available space and adjacent to the first electronic enclosure. That is, the first and second electronic enclosures are removably secured to a respective one of the front mounting members such that they are both provided as independent devices alongside one another within the predetermined width defined by the mounting members.

The width of the electronic enclosure is preferably selected to be half that of the predetermined width of the equipment rack. In this way, two electronic enclosures of the same width are able to be mounted alongside one another within the predetermined width defined by the mounting members. Conveniently, the two electronic enclosures are arranged to be of the same height. Alternatively, the two electronic enclosures, though able to be mounted side-by-side, may be of differing heights.

The use of two or more half-width electronic enclosures within the equipment rack enables an increase of the packing density within the rack. The “packing density” within the equipment rack essentially relates to the number of independent items of equipment that are able to be housed or mounted within the equipment rack or a portion of space within the rack. For example, the packing density within a portion of rack space may be increased by replacing a 2U full-width computer server with two 2U half-width computer servers.

The electronics equipment rack is preferably an industry standard equipment rack having a predetermined width of 19-inches that permits retainment of electronic enclosures or packages that fit into a cavity within the 19-inch wide rack (ie. the actual cavity is 17.75-inches wide). Conveniently, the electronics equipment rack comprises a structural frame defined by two front mounting members and two rear mounting members. The mounting members are connected to each other with a plurality of cross members and structural supports and arranged to support the weight of the electronic enclosures contained within the rack. The mounting members, essentially four rigid corner posts, serve as the primary means for securing the electronic enclosures within the equipment rack. Conveniently, the electronic enclosure is removably secured to only one of the two front mounting members.

Each of the mounting members include a plurality of mounting holes which enable the electronic enclosures to be secured to the rack. To be compatible with industry standard equipment racks, the height of the electronic enclosure must essentially be an integer multiple of a U unit. A U is essentially a vertical unit equating to a height of 1.75-inches (44.45 mm). Conveniently, the height of the electronic enclosure may be any one of a range of standard heights including 1U (1.75-inch), 2U (3.50-inch), 3U (5.25-inch), 4U (7.00-inch), 5U (8.75-inch) or 6U (10.50-inch). Conveniently, the height of the electronic enclosure is directly linked to the specific function and height requirements of the electronic components required to be housed by the electronic enclosure.

Preferably, the electronic enclosure comprises an outer housing with the one or more electronic components being arranged within the outer housing. Conveniently, the outer housing is configured to include the two opposing sides and a front and a rear. Preferably, one of the sides of the housing is adapted to enable the electronic enclosure to be mounted to a respective one of the front two mounting members.

The electronic enclosure is conveniently removably secured to one of the two front mounting members by way of two or more securement means which engage respective mounting holes in the mounting member. Conveniently, the securement means are screw fasteners which are the only means provided to secure the electronic enclosure to the mounting members. Preferably, where the enclosure is 1U in height, two screw fasteners are provided to secure the enclosure to one of the two front mounting members of the equipment rack. Preferably, where the enclosure is greater than 1U in height (eg. 2U, 3U, 4U etc), two or more screw fasteners are provided to secure the enclosure to one of the two front mounting members of the equipment rack. The number of fasteners required will typically depend on the particular height, weight and function of the electronic enclosure.

Preferably, where the width of the electronic enclosure is half that of the predetermined width of the equipment rack and two such electronic enclosures are mounted in the equipment rack in a side-by-side arrangement, the two enclosures may also be removably secured to one another. Accordingly, as well as each electronic enclosure being secured to a respective one of the front mounting members, the enclosures are further supported within the equipment rack by virtue of their securement to each other. This may provide for enhanced support for each electronic enclosure.

In such an arrangement, the two half-width electronic enclosures occupy the space which would normally be filled-by a single electronic enclosure of standard width which spans the entire predetermined width of the equipment rack. Such a full-width electronic enclosure would also require securement to both front mounting members to enable the full-width enclosure to be retained within the equipment rack.

Preferably, the half-width enclosure is of a height which more readily enables an increased number of components to be housed within the enclosure whilst permitting additional functionality to be provided thereby. That is, certain low height enclosures (eg. 1U high enclosures) often do not enable the use of, for example, multiple 3.5-inch hard disk drives or the ability to fit multiple expansion cards, within the electronic enclosure. Where the electronic enclosure is 2U or more in height, the density of components within the enclosure may be increased whilst still allowing other functionality to be provided thereby (eg. physically higher items may be able to be housed in the enclosure whilst still achieving an increase in density).

Preferably, the electronic enclosure is configured to provide a component density within the outer housing which is at least equivalent to a 1U high full-width package which would normally be mounted in the equipment rack. For example, a half-width enclosure of 2U height may be able to provide an equivalent or increased component density to a 1U high full-width package whilst enabling certain deficiencies of the 1U high full-width package to be overcome. Conveniently, the electronic enclosure is configured to provide a component density within the outer housing which is at least equivalent to a 2U high full-width package which would normally be mounted in the equipment rack.

The electronic enclosure may alternatively be configured with a width which is smaller than the predetermined width of the equipment rack by a different proportion (ie. than half-width). Conveniently, the width of the electronic enclosure may be one third that of the predetermined width of the equipment rack. In this case, when mounted in the equipment rack by securement to one of the two front mounting members, the available space created adjacent one side of the electronic enclosure is twice the width of the electronic enclosure (ie. permitting securement of, for example, a two thirds width enclosure adjacent the one third width enclosure). However, if a second electronic enclosure of one third-width were to be removably secured to the other of the front mounting members at the same height as the first electronic enclosure, there would still exist an available space between the first and second one third enclosures. Conveniently, a third electronic enclosure of one third-width may fill this available middle space such that three one third-width enclosures arranged side-by-side would occupy the space which would normally be filled by a single electronic enclosure which would normally span the entire predetermined width of the equipment rack.

Preferably, in such an arrangement, each adjacent electronic enclosure would also be removably secured to one another such that the middle enclosure could be supported within the equipment rack. That is, the middle electronic enclosure would not be secured to either of the two front mounting members, but rather would be secured to each of the one third-width enclosures arranged on either side thereof. Similar comments apply in relation to the provision of one quarter-width electronic enclosures or any other proportional variant which may have particular applicability in specific circumstances.

In each case where more than one electronic enclosure is able to be provided in a side-by-side arrangement within the predetermined width defined by the two front or rear mounting members of the equipment rack, an array of electronic enclosures is essentially able to be provided in contrast to a single electronic enclosure spanning the entire predetermined width of the equipment rack. This is particularly beneficial in increasing the packing density within the equipment rack whilst also enabling different half or one third-width compact electronic enclosures to be removed from the equipment rack without the need to remove an adjacent electronic enclosure.

Conveniently, the outer housing of the electronic enclosure comprises a flange which enables the electronic enclosure to be removably secured to one of the mounting members. Preferably, the flange is dependant from one of the sides of the electronic enclosure such that this side of the electronic enclosure is located adjacent to the mounting member when the enclosure is secured thereto with the fastener screws. Alternatively, a separate mounting bracket may be provided for attachment to one side of the electronic enclosure, the bracket also enabling the enclosure to be removably secured to a respective one of the mounting members. The flange or bracket is conveniently provided with two or more apertures to enable two or more fastener screws to engage two or more respective mounting holes in the adjacent mounting member. Conveniently, the bracket may be configured such that it may be fitted to either side of the electronic enclosure such that the enclosure may be removably secured to either of the mounting members of the rack (eg. to the left-hand or right-hand front mounting member).

As alluded to above, adjacent electronic enclosures (eg. two half-width enclosures, a one third width and a two third width enclosure, three one third-width enclosures, etc) may conveniently be secured to one another to provide enhanced support to one another when mounted in the equipment rack. Conveniently, adjacent electronic enclosures may be removably secured to one another by way of removable fasteners which engage corresponding apertures in adjacent sides of the outer housings. Alternatively, an easily releasable interengaging arrangement provided on adjacent sides of the outer housings may enable two adjacent electronic enclosures to be secured to one another. For example, the adjacent sides of the outer housings may be provided with complementary male and female coupling means which are able to lock together when the electronic enclosures are retained in a side-by-side arrangement.

Preferably, two adjacent electronic enclosures provided side-by-side within the predetermined width of the mounting members may be secured to one another by way of at least one joining member. The joining member is conveniently configured such that it may be removably secured to the outer housings of each adjacent electronic enclosure by way of suitable securement means such as screw fasteners. Preferably, the joining member is configured as a plate having apertures arranged on opposing sides thereof, the apertures aligning with corresponding apertures in the outer housings of each of the two adjacent enclosures such that the enclosures are secured with respect to one another when the joining plate is secured to the respective enclosures with the screw fasteners. The joining member may conveniently be attached to two corresponding surfaces of the enclosures when the electronic enclosures are arranged side-by-side.

Preferably, the joining plate is secured to the front of each respective outer housing at a location adjacent the corresponding sides of the enclosures when arranged side-by-side. Preferably, the joining plate is secured to the rear of each respective outer housing at a location adjacent the corresponding sides of the enclosures when arranged side-by-side. Conveniently, joining plates may be provided at both the front and rear of the outer housings of adjacent enclosures to provide additional support for the enclosures when mounted in the equipment rack.

Conveniently, one or more half-width electronic enclosures may also or alternatively be removably secured to the rear mounting members of the equipment rack. That is, provided the depth of a half-width enclosure is less than half the depth of the equipment rack, an array of half-width, half depth enclosures may be mounted in the same vertical plane within the rack. Preferably, where a number of electronic enclosures are mounted to both the front and rear mounting members of the equipment rack, two enclosures are secured to the two front mounting members and another two enclosures are secured to the two rear mounting members. Conveniently, such a combination of front and rear mounted enclosures is provided in a “back-to-back” configuration. Such a configuration has the capability of significantly enhancing the packing density within the equipment rack.

For example, it may be possible that, in a 1U space within the rack previously occupied by a single full-width enclosure of half depth or more, that up to four individual half-width 1U enclosures of half depth or less may now be accommodated. Hence, such a back-to-back arrangement may enable the entire front to rear volume of each 1U unit of height in the rack to be occupied and hence maximise the utilisation of the available rack space.

There is also provided according to the present invention an electronic enclosure mounting arrangement including a first electronic enclosure adapted to be mounted in an industry standard electronics equipment rack, the electronics equipment rack being of a predetermined width which is in part defined by the distance between two front mounting members which form part of the equipment rack, the first electronic enclosure. comprising an outer housing including a front, a rear, and two opposing sides which define the width thereof, said outer housing being configured to house one or more electronic components which are operatively coupled to provide a specific function, wherein the width of the first electronic enclosure is proportionally smaller than the predetermined width of the electronics equipment rack, the first electronic enclosure being removably secured to only one of the mounting members of the electronics equipment rack, and wherein a second electronic enclosure having an outer housing similar in width to the first electronic enclosure is able to be arranged alongside the first electronic enclosure with means also being provided to enable the adjacent first and second electronic enclosures to be secured to one another.

Preferably, the first electronic enclosure is removably secured to a first front mounting member of the equipment rack and the second electronic enclosure is removably secured to a second front mounting member of the equipment rack. Preferably, the first and second enclosures are secured to one another by way of a joining member removably secured to the outer housings of each electronic enclosure.

Where the electronic enclosure serves as a computer server or like processing device, the configuration of the enclosure enables physically small computers to be provided and hence the ability to increase the packing density of such computer servers or the like in standard 19-inch equipment racks. The enclosure and means for mounting the enclosure in a standard equipment rack also facilitates a low cost option by which a large number of independent computer servers or similar devices can be fitted into a standard 19-inch equipment rack.

There is further provided according to the present invention a system for mounting a plurality of independent electronic enclosures in an industry standard electronics equipment rack, the electronics equipment rack being of a predetermined width which is in part defined by the distance between a left-hand and a right-hand mounting member which form part of the equipment rack, each electronic enclosure comprising a front, a rear, and two opposing sides, the width of each electronic enclosure being defined by the two opposing sides and being proportionally smaller than the predetermined width of the electronics equipment rack, the system including providing an array of two or more electronic enclosures in a side-by-side arrangement within the predetermined width of the equipment rack and removably securing at least two electronic enclosures of the side-by-side arrangement to only a respective one of the mounting members of the electronics equipment rack.

Conveniently, each of the electronic enclosures of the side-by-side arrangement are also removably secured to one or more of the electronic enclosures to which it is arranged alongside.

### BRIEF DESCRIPTION OF THE DRAWINGS

It will be convenient to further describe the present invention with respect to the accompanying drawings which illustrate possible embodiments of the invention. Other embodiments of the invention are possible and, consequently, the particularity of the accompanying drawings is not to be understood as superseding the generality of the preceding description of the inventions.

FIG. 1 is a schematic front view of a single half-width electronic enclosure mounted in an industry standard electronics equipment rack;

FIG. 2 is a schematic front view of an array of 1U and 2U half-width electronic enclosures mounted in an identical industry standard electronics equipment rack to that depicted in FIG. 1;

FIG. 3 is a schematic rear view of two adjacent 2U half-width electronic enclosures arranged side-by-side and secured at their rear faces by a single joining plate;

FIG. 4 is a schematic rear view of two 1U half-width electronic enclosures arranged alongside a 2U half-width electronic enclosure with each 1U enclosure being secured to the 2U enclosure by separate joining plates; and

FIG. 5 is a schematic front view of a half-width electronic enclosure and a removable mounting bracket which may be secured on either side of the electronic enclosure to enable mounting in an equipment rack.

### BEST MODE(s) FOR CARRYING OUT THE INVENTION

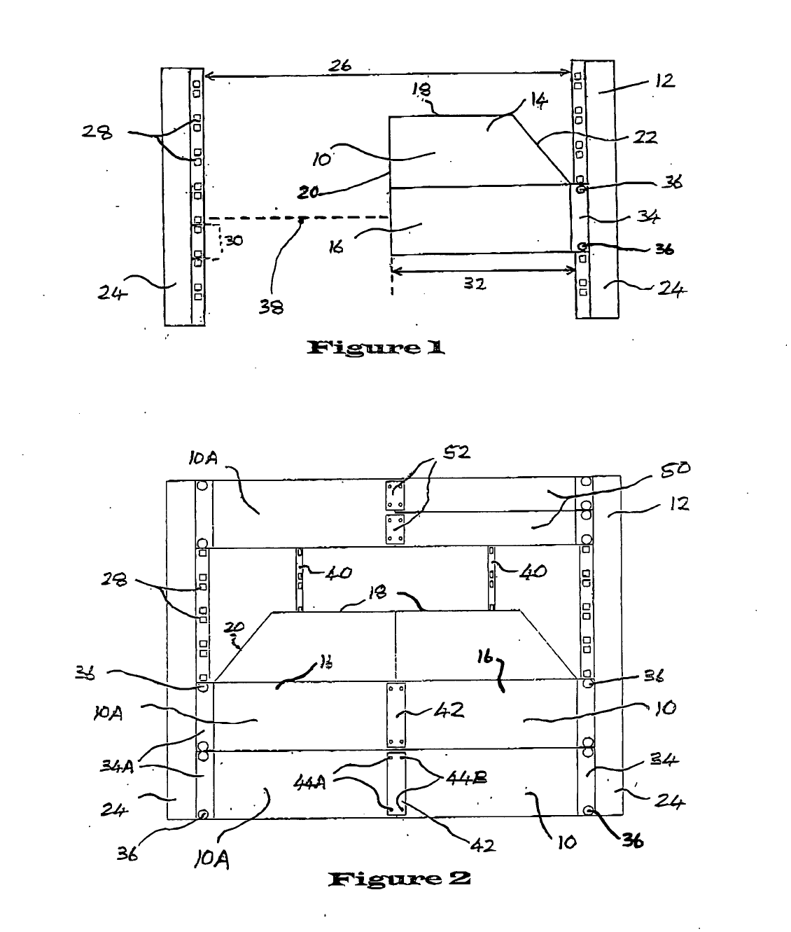

FIG. 1 shows an electronic enclosure 10 mounted in an industry standard equipment rack 12. The electronic enclosure 10 comprises an outer housing 14 having a front 16, a rear 18 and two opposing sides 20 and 22. The electronic enclosure is configured to house one or more electronic components (not shown) which are operatively coupled to provide a specific function. For example, the electronic enclosure 10 may function as a typical computer server and hence include a power supply, motherboard, processing means, hard disk drive and various I/O means.

The equipment rack 12 is well know in the electronics and computing industries and comprises a structural frame defined by two front mounting members 24 and two rear mounting members (not shown), the rack 12 being designed to house a column of electronics packages or enclosures of varying depths. The mounting members are typically affixed to each other with a plurality of cross members and structural supports (not shown) and arranged to support the weight of a number of electronic enclosures contained within the rack 12. The equipment rack 12 has a predetermined width of 19-inches as indicated at 26 and can allow retainment of electronic enclosures or packages that fit into a cavity within the 19-inch wide rack (NB. the actual cavity is 17.75-inches wide).

The mounting members, essentially four rigid corner posts, serve as the primary means for securing the electronic enclosures within the equipment rack 12. Each of the mounting members 24 include a plurality of mounting holes 28 which enable the electronic enclosures to be secured to the rack 12. To be compatible with the industry standard equipment rack 12, the height of the electronic enclosures are normally an integer multiple of a defined “U” unit. A U is essentially a vertical unit equating to a height of 1.75-inches (44.45 mm) and the mounting holes 28 are arranged and spaced along the length of each mounting member to provide for the adjacent vertical location of individual electronic enclosures along the vertical length of rack 12. For example, the spacing of adjacent mounting holes 28 for a 1U high package is shown at 30.

In prior art arrangements, electronic enclosures or packages are typically configured to fill the full-width 26 of the equipment rack 12 and are secured at both sides thereof to each of the front mounting members 24. The height of the electronic enclosures varies depending upon the specific function and height requirements of the electronic components inside the electronic enclosure and may for example be any one of a range of standard heights such as 1U (1.75-inch), 2U (3.50-inch), 3U (5.25-inch), 4U (7.00-inch), 5U (8.75-inch) or 6U (10.50-inch). The enclosure 10 in FIG. 1 is a 2U high device.

As can be seen at 32 in FIG. 1, the electronic enclosure 10 is proportionally smaller than the predetermined width 26 of the equipment rack 12 and in the embodiment shown is essentially one half of the width 26 of the equipment rack 12. That is, the electronic enclosure 10 is essentially a half-width 2U high enclosure. The enclosure 10 comprises a flange 34 which is arranged at the vertical junction of the front 16 and right hand side 22 of the outer housing 14. The flange 34 enables the enclosure 10 to be removably secured to one of the front mounting members 24 (ie. that on the right-hand side of the rack 12). It is to be noted that a similar flange is not provided at the left hand side 20 of the front 16 of the outer housing 14.

The flange 34 comprises a plurality of apertures (not shown) that are located and spaced to correspond with a number of the mounting holes 28 in the mounting member 24. In the embodiment shown, two screw fasteners 36 are used to removably secure the electronic enclosure 10 to the right-hand mounting member 24. It is however to be noted that, for enclosures which are 2U or greater in height, there exists the option of using more than two screw fasteners, where appropriate, to aid in securing the enclosure within the rack 12. However, in its most basic form, the invention does not require any further securement means to retain the enclosure 10 in the rack 12.

As the half-width enclosure 10 does not span the entire width 26 of the equipment rack 12, it is evident that an available space 38 is created adjacent to the enclosure 10 (ie. adjacent the left-hand side 20 thereof). As will be further explained with reference to FIG. 2, this available space 38 may be used to accommodate a second half-width enclosure arranged alongside the first enclosure 10.

FIG. 2 depicts the same electronic equipment rack 12, however in this embodiment, the rack 12 (for which rear mounting members 40 are visible) is shown to contain an array of 1U and 2U half-width electronic enclosures. At the lower portion of the rack 12, two half-width 2U enclosures 10 similar to that described with reference to FIG. 1 are shown with each enclosure 10 being removably secured to one of the front mounting members 24 as previously described. However, the available space which was evident alongside the enclosure 10 as described in FIG. 1 has in this embodiment essentially been filled by a similar half-width enclosure 10A. The half-width enclosures 10A are each mounted to the other of the front two mounting members 24 (ie. that on the left-hand side of the rack 12) by way of a flange 34A which is arranged at the vertical junction of the front 16 and left-hand side 20 of the outer housings 14 of each enclosure 10A. That is, each of the half-width 2U enclosures 10, 10A shown in the lower portion of the rack 12 are only secured to one of the front mounting members 24.

In this way, the space which would normally have been occupied by a single 2U package spanning the entire width 26 of the equipment rack 12 has effectively been replaced by two separate half-width 2U enclosures 10, 10A Hence, such a side-by-side arrangement of half-width enclosures enables the packing density of the 2U space to be enhanced by a factor of two. The enclosures 10, 10A are however maintained independent from one another thus permitting the easy exchange or removal of the enclosures 10, 10A from the rack 12.

To provide further support to the half-width enclosures 10, 10A retained in the equipment rack 12, it may be desirable to secure adjacent enclosures with respect to one another. That is, each adjacent half-width 2U enclosure 10, 10A (ie. those arranged alongside one another) may optionally be secured to one another to provide further structural support therefor. In the embodiment shown in FIG. 2, this is achieved by way of a joining plate 42 which is provided at the front 16 of each adjacent half-width 2U enclosure 10, 10A. The need for such a joining plate 42 may be dependant upon the particular application and/or the weight of the electronic enclosure 10, 10A.

The joining plate 42 is provided with an aperture at each corner to enable a screw fastener (not shown) to engage therewith and provide securement to each of the enclosures 10, 10A. That is, the apertures 44A on the left-hand side of the plate 42 enable securement of the plate 42 to the enclosure 10A whilst the apertures 44B on the right-hand side of the plate 42 enable securement of the plate 42 to the enclosure 10. The adjacent enclosures 10, 10A have their respective sides 20 and 22 adjacent one another such that the single joining plate 42 of suitable width is sufficient to enable the enclosures 10, 10A to be firmly secured to one another. The joining plate 42 is approximately the same height as the enclosures 10, 10A (ie. 2U in height).

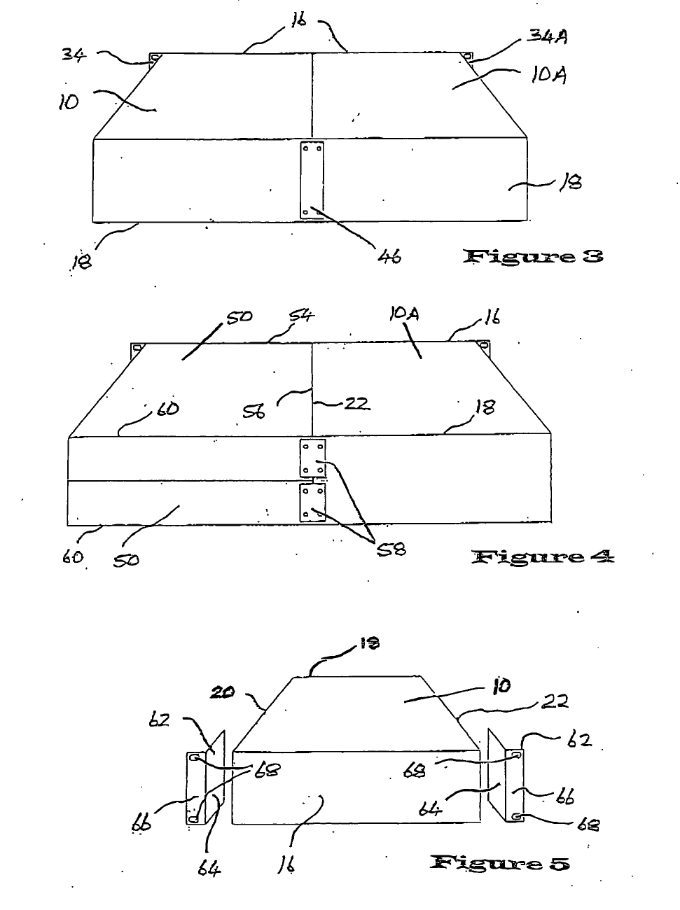

As can be seen from FIG. 3, it may also be desirable to provide a further joining plate 46 at the rear 18 of the enclosures 10, 10A. The further joining plate 46 may be of the same shape and configuration as joining plate 42 with the only difference being it is applied at the rear 18 of each adjacent enclosure 10, 10A to provide additional support for each enclosure 10, 10A. It is of course possible that the further joining plate 46 may be provided instead of the joining plate 42 depending upon the nature of the electronic enclosure 10, 10A and in particular the configuration of the outer housings 14 thereof. Furthermore, whilst the joining plates 42, 46 have been shown as simple rectangular plates, it is to be appreciate that alternative shapes and arrangements for such joining plates may be possible (eg. the shape thereof and/or the locations of the apertures therein may be modified to correspond to features of the outer housing of the or each enclosure 10, 10A).

Still further, it is to be appreciated that alternative means by which the two adjacent enclosures 10, 10A are secured may be adopted. For example, the enclosures 10, 10A may be fixedly secured to one another at some point along the adjacent sides 20, 22 thereof such as by a simple fastening means. Alternatively, an easily releasable arrangement may be provided with corresponding male and female interengaging members being arranged on respective sides 20, 22 of the enclosures 10, 10A.

FIG. 2 also shows how two half-width 1U electronic enclosures 50 arranged vertically adjacent to one another may be arranged adjacent a single half-width 2U enclosure 10A in the same equipment rack 12. In the array of enclosures as shown in the upper portion of the rack 12, the space which would normally have been occupied by a single 2U package spanning the entire width 26 of the equipment rack 12 has effectively been replaced by three separate half-width packages, two half-width 1U enclosures 50 and a single half-width 2U enclosure 10A. As with each of the half-width enclosures as previously described, each of the half-width enclosures 10A, 50 is only secured to one of the front mounting members 24.

However, so far as this mixed array of enclosures 10A, 50 is concerned, in order to maintain the ability to remove and replace each enclosure 10A, 50 independently of the other enclosures 10A, 50 arranged adjacent thereto, it is desirable that each half-width 1U enclosure 50 is separately secured to the half-width 2U enclosure 10A arranged alongside the enclosures 50. Accordingly, as best appreciated from a consideration of FIGS. 2 and 4, a 1U high joining plate 52 is used to secure the front 54 left-hand side 56 of each half-width 1U enclosure 50 to the front 16 right-hand side 22 of the half-width 2U enclosure 10A. Still further, similar rear 1U joining plates 58 may also or alternatively be provided to secure each half-width 1U enclosure 50 with the half-width 2U high enclosure 10A at the rears 60, 18 thereof.

Hence, it is evident from FIGS. 2, 3 and 4 that a multitude of mounting combinations of half-width enclosures of differing heights may be possible in the standard equipment rack 12. Whilst 1U, 2U and 3U high electronic enclosures are envisaged as being the more common configurations likely to be used, enclosures of other heights are also feasible. Similar comments of course apply in regard to enclosures of different widths such as one third-width enclosures or one quarter-width enclosures. It is however to be noted with such smaller width enclosures that one or more enclosures situated in the middle of an array of side-by-side enclosures will not be secured to either of the front mounting members 24 of the rack 12. For example, in the case of three one third-width 2U high enclosures arranged in a side-by-side arrangement within the rack 12, the middle enclosure cannot be secured to either of the front mounting members 24 by virtue of its separation therefrom by each of the one third-width enclosures arranged alongside the middle enclosure. However, the middle one third-width enclosure would be secured to each of the adjacent one third-width enclosures by suitable joining plates (ie. arranged at the front and/or back of the enclosures at the junctions therebetween) such that it too was able to be removably secured with respect to the equipment rack 12. The left and right hand side one third-width enclosures would of course be secured to respective front mounting members 24 of the rack 12.

The enclosure 10, 10A, 50 as described above still enables any required connectors and other components (eg. such as optical or floppy disk drives) to be mounted at the front 16 or rear 18 of the outer housing 14, as would be the case with full-width electronic modules. Furthermore, the enclosure 10, 10A, 50 can facilitate the requirement for all connectors, I/O devices etc to be mounted at the front 16, or the rear 18 of the enclosure 10, 10A, 50 if so desired. Where the electronic enclosure 10, 10A, 50 is of 2U height or greater, the effective cooling of the electronic components within the outer housing 14 may be improved (ie. as compared to a minimum height 1U high enclosure) due to the ability to more effectively draw air into the housing 14 and circulate the air around the components within the enclosure 10, 10A, 50 more freely.

Although not shown, the electronic enclosure 10, 10A. 50 as described may be provided with an appropriately sized handle at the front 16 of the outer housing 14. The provision of such a handle may render the enclosure easier to remove from a fully populated equipment rack 12.

FIG. 5 shows an alternative means for mounting the half-width enclosure 10 as described with reference to FIG. 1 to the equipment rack 12. Rather than the outer housing 14 of the enclosure 10 comprising a flange 34, 34A, a connecting bracket 62 may be provided for enabling the removable securement of the enclosure 10 to one of the two front mounting members 24. The connecting bracket 62 may be of a simple angled construction such that a first portion 64 thereof enables attachment to a side 20, 22 of the enclosure 10 whilst a second portion 66 enables attachment to the one of the front mounting members 24. The second portion 66 comprises a plurality of apertures 68 spaced and located so as to correspond with the mounting holes 28 in the front mounting members 24. In the embodiment shown in FIG. 5, the connecting bracket 62 is of the same height as the enclosure 10. The connecting bracket 62 is able to be attached to either side 20, 22 of the enclosure 10 adjacent the front 16 thereof to enable the half-width enclosure 10 to be secured to and retained in the rack 12 in the manner as previously described. Similarly, because the connecting bracket 62 is able to be removably secured to the enclosure 10 and one of the mounting members 24, it facilitates the quick and easy removal of the half-width enclosure without the need to remove a separate half-width enclosure to which it may be arranged alongside.

Whilst it is evident that the half-width enclosure may be of any depth, in the case where it were to extend the full depth of the equipment rack 12, there is of course the option of also securing the enclosure 10 to the corresponding rear mounting member 40 of the rack 12. Such securement would typically be made possible by way of similar means provided at the rear 18 of the enclosure 10 (eg. a corresponding flange 34 to enable the rear 18 of the enclosure to be removably secured to the corresponding rear mounting member 40). The enclosure 10 would of course still only occupy half the width of the predetermined width 26 of the equipment rack 12 even though the enclosure 10 extends over the full depth of the rack 12.

In an attempt to further conserve space in the equipment rack 12, it may be possible in certain circumstances to also mount one or more half-width enclosures 10 at the rear of the equipment rack 12. That is, provided the depth of a half-width enclosure 10 is less than half the depth of the equipment rack 12, an array of half-width, half-depth enclosures may be mounted in the same vertical plane within the rack, two from the front and another two from the rear in a “back-to-back” configuration. Provided the relative depths of each half-width enclosure enable such an arrangement to be used, this may be one desirable way to significantly enhance the packing density within the rack 12.

For example, it may be possible that, in a 1U space within the rack 12 previously occupied by a single full-width enclosure of half depth or more, that up to four individual half-width 1U enclosures of half depth or less may now be accommodated. Hence, such a back-to-back arrangement of half-width enclosures enables the packing density of the 1U space to be enhanced by a factor of four. Depending upon the particular circumstances and the individual depths of the electronic enclosures, it may be convenient that all connectors, cables and I/O devices are provided at the front 16 of the outer housings 14 for ease of accessibility and maintenance.

The present invention provides a simple and low cost means of having independent self-contained electronic enclosures or modules mounted into an industry standard 19-inch electronics equipment rack, whereby the enclosures or modules are in height multiples of 1U (ie. the minimum height, and the height multiple, of a rack mount enclosure), can have varying depths, and do not have to be the full-width of the 19-inch equipment rack. A high density rack mounting arrangement for computers, servers and associated equipment is able to be realised whilst cost is able to be kept to a minimum. Half-width or proportionally smaller enclosures such as those contemplated by the present invention do not necessitate any mounting shelves, shells, carriers, chassis or backplanes to enable the enclosures to be mounted for use in the standard equipment rack, each of which would typically necessitate an increase in cost. Still further, the invention enables commercial off-the-shelf components to be used in the enclosure thus further reducing the overall cost thereof (ie. for higher density servers etc). The ability to increase the packing density of computer servers or the like in electronic racks and hence in commercial server rooms also enables significant cost savings to be realised.

Furthermore and importantly, the ability to use and satisfactorily mount electronic enclosures which are less than the standard width 26 of the equipment rack 12, (ie. typically half the width) results in an effective increase in the density of the equipment able to be accommodated in the rack 12. For example, there is typically a certain proportion of wasted space in full-width modules or electronic enclosures. Low height modules (eg. 1U high enclosures) also often result in some functionality being removed from the enclosure (ie. less equipment can be housed in the low height enclosure, such as for example expansion cards). By enabling the use of half-width electronic enclosures, there is the potential for less wasted space within the equipment rack 12, as the component density within the enclosure may be increased, thus allowing the packing density of the overall equipment rack to be increased. This is achieved whilst still allowing other functionality to be provided in the electronic enclosures, such as the use of multiple hard disk drives per server, 3.5-inch hard disk drives instead of 2.5-inch drives, PCI bus cards for expansion purposes and the ability to fit multiple expansion cards.

By way of example, a key benefit of the half-width type enclosure is that the typical components required in a general-purpose server-computer can be fitted into a 2U high half-width enclosure relatively easily and with no or fewer air-flow compromises. This hence results in a more reliable solution with at least the same, though a more likely improved, packing density as compared with a standard 1U full-width solution. Whilst it may be the case that the same number of components can be housed in a full-width 1U high enclosure, the 1U high enclosure may need to be a lot deeper. By using the half-width enclosure, a greater number servers are able to be retained in a given rack space (particularly where servers are able to be mounted on both the front and rear faces of the equipment rack).

Still further, the present invention enables the use of independent computer servers whilst enhancing the packing density within the equipment rack. This is seen as a more desirable alternative than housing two or more servers (ie. requiring two or more motherboards, power supplies etc) into a single enclosure where each server is no longer independent (ie. if one server fails, then each server housed in the single enclosure needs to be turned off such that the faulty item can be repaired or replaced).

Even though the present invention has predominantly been described with reference to industry standard 19-inch electronic equipment racks, it is of course equally applicable to other electronics racks which may be used in the computing, communication and electronics industry. For example, the same invention could be implemented in 19-inch Telco racks and 23-inch wide equipment racks. 23-inch wide racks are for example typically used in telephone exchanges. Telco racks are generally two post based, typically 600 mm deep (ie. rather than four post based and 600+mm deep) equipment racks. Back-to-back mounting for example is not possible in Telco racks as the mounting members are in the middle of the rack cavity, and the two rear mounting members do not exist, though there still exists the possibility of increasing the density of rack based equipment of this type. For example, a tape backup unit may be fitted into a half-width electronic enclosure, rather than being placed on a full-width 2U high rack shelf. Networking equipment, such as Ethernet switches for example, could potentially also be fitted into a half-width electronic enclosure.

Whilst the present invention has in the main been described with respect to half-width electronic enclosures adapted for mounting in an industry standard equipment rack, it is to be appreciated that other configurations of electronic enclosures may be also be possible without detracting from the nature of the present invention. For example, electronic enclosures of one third-width and one quarter-width of the predetermined width 26 of the standard equipment rack 12 may also have application in various specific circumstances.

Throughout the specification, unless the context requires otherwise, the word “comprise” or variations such as “comprises” or “comprising”, will be understood to imply the inclusion of a stated integer or group of integers but not the exclusion of any other integer or group of integers.

Modifications and variations as would be deemed obvious to the person skilled in the art are included within the ambit of the present invention.

1. An electronic enclosure adapted to be mounted in an electronics equipment rack, the electronics equipment rack being of a predetermined width which is in part defined by the distance between two mounting members which form part of the equipment rack, the electronic enclosure comprising two opposing sides which define the width thereof, said enclosure being configured to house one or more electronic components which are operatively coupled to provide a specific function, wherein the width of the electronic enclosure is proportionally smaller than the predetermined width of the electronics equipment rack and wherein the electronic enclosure is removably secured to only one of the mounting members of the electronics equipment rack such that an available space is provided alongside the electronic enclosure when it is mounted in the electronics equipment rack.

2. An electronic enclosure according to claim 1 wherein the available space adjacent the electronic enclosure may be occupied by a second electronic enclosure also adapted to be mounted in the electronics equipment rack.

3. An electronic enclosure according to claim 2 wherein the second electronic enclosure is removably secured to the other of the mounting members such that it is located within the available space and adjacent to the first electronic enclosure.

4. An electronic enclosure according to claim 1 wherein the width of the electronic enclosure is selected to be half that of the predetermined width of the equipment rack.

5. An electronic enclosure according to claim 1 wherein the electronics equipment rack is preferably an industry standard equipment rack having a predetermined width of 19-inches that permits retainment of electronic enclosures or packages that fit into a cavity within the 19-inch wide rack.

6. An electronic enclosure according to claim 5 wherein the height of the electronic enclosure may be any one of a range of standard heights including 1U (1.75-inch), 2U (3.50-inch), 3U (5.25-inch), 4U (7.00-inch), 5U (8.75-inch) or 6U (10.50-inch).

7. An electronic enclosure according to claim 5 wherein the height of the electronic enclosure is directly linked to the specific function and height requirements of the electronic components required to be housed by the electronic enclosure.

8. An electronic enclosure according to claim 1 wherein the electronic enclosure comprises an outer housing configured to include the two opposing sides and wherein one of the sides of the housing is adapted to enable the electronic enclosure to be mounted to a respective one of the two mounting members.

9. An electronic enclosure according to claim 1 wherein the electronic enclosure is conveniently removably secured to one of the two mounting members by way of two or more securement means which engage respective mounting holes in the mounting member, the securement means being the only means provided to secure the electronic enclosure to the mounting members.

10. An electronic enclosure according to claim 1 wherein the width of the electronic enclosure is half that of the predetermined width of the equipment rack and two such electronic enclosures are mounted in the equipment rack in a side-by-side arrangement and wherein the two enclosures are also removably secured to one another.

11. An electronic enclosure according to claim 10 wherein the half-width enclosure is of a height which more readily enables an increased number of components to be housed within the enclosure whilst permitting additional functionality to be provided thereby.

12. An electronic enclosure according to claim 10 wherein the electronic enclosure is configured to provide a component density which is at least equivalent to a 1U high full-width package which would normally be mounted in the equipment rack.

13. An electronic enclosure according to claim 10 wherein the electronic enclosure is configured to provide a component density which is at least equivalent to a 2U high full-width package which would normally be mounted in the equipment rack.

14. An electronic enclosure according to claim 1 wherein the width of the electronic enclosure may be one third that of the predetermined width of the equipment rack.

15. An electronic enclosure according to claim 14 wherein a second electronic enclosure of one third-width is removably secured to the other of the mounting members at the same height as the first electronic enclosure, thereby creating an available middle space between the first and second one third enclosures.

16. An electronic enclosure according to claim 15 wherein a third electronic enclosure of one third-width is arranged within the available middle space such that three one third-width enclosures arranged side-by-side occupy the space which would normally be filled by a single electronic enclosure which would normally span the entire predetermined width of the equipment rack.

17. An electronic enclosure according to claim 16 wherein each adjacent electronic enclosure is removably secured to one another such that the middle enclosure may also be supported within the equipment rack.

18. An electronic enclosure according to claim 1 wherein an array of side-by-side electronic enclosures is provided across the predetermined width of the equipment rack.

19. An electronic enclosure according to claim 8 wherein the outer housing comprises a flange which enables the electronic enclosure to be removably secured to one of the mounting members.

20. An electronic enclosure according to claim 8 wherein a separate mounting bracket may be provided for attachment to one side of the electronic enclosure, the bracket enabling the enclosure to be removably secured to a respective one of the mounting members.

21. An electronic enclosure according to claim 20 wherein the bracket may be configured such that it may be fitted to either side of the electronic enclosure such that the enclosure may be removably secured to either of the mounting members of the rack.

22. An electronic enclosure according to claim 18 wherein adjacent electronic enclosures may be removably secured to one another by way of removable fasteners which engage corresponding apertures in adjacent sides thereof.

23. An electronic enclosure according to claim 18 wherein an easily releasable interengaging arrangement is provided on adjacent sides of two side-by-side electronic enclosures to enable the adjacent electronic enclosures to be secured to one another.

24. An electronic enclosure according to claim 18 wherein two adjacent electronic enclosures provided side-by-side within the predetermined width of the mounting members may be secured to one another by way of at least one joining member.

25. An electronic enclosure according to claim 24 wherein the joining member is attached to two corresponding surfaces of the side-by-side electronic enclosures.

26. An electronic enclosure according to claim 1 wherein the electronic enclosure is secured to front mounting members of the equipment rack and wherein one or more additional electronic enclosures may also be removably secured to rear mounting members of the equipment rack.

27. An electronic enclosure mounting arrangement including a first electronic enclosure adapted to be mounted in an industry standard electronics equipment rack, the electronics equipment rack being of a predetermined width which is in part defined by the distance between two front mounting members which form part of the equipment rack, the first electronic enclosure comprising an outer housing including a front, a rear, and two opposing sides which define the width thereof, said outer housing being configured to house one or more electronic components which are operatively coupled to provide a specific function, wherein the width of the first electronic enclosure is proportionally smaller than the predetermined width of the electronics equipment rack, the first electronic enclosure being removably secured to only one of the mounting members of the electronics equipment rack, and wherein a second electronic enclosure having an outer housing similar in width to the first electronic enclosure is able to be arranged alongside the first electronic enclosure with means also being provided to enable the adjacent first and second electronic enclosures to be secured to one another.

28. An electronic enclosure mounting arrangement according to claim 27 wherein the first electronic enclosure is removably secured to a first front mounting member of the equipment rack and the second electronic enclosure is removably secured to a second front mounting member of the equipment rack.

29. An electronic enclosure mounting arrangement according to claim 28 wherein the first and second enclosures are secured to one another by way of a joining member removably secured to the outer housings of each electronic enclosure.

30. A system for mounting a plurality of independent electronic enclosures in an industry standard electronics equipment rack, the electronics equipment rack being of a predetermined width which is in part defined by the distance between a left-hand and a right-hand mounting member which form part of the equipment rack, each electronic enclosure comprising a front, a rear, and two opposing sides, the width of each electronic enclosure being defined by the two opposing sides and being proportionally smaller than the predetermined width of the electronics equipment rack, the system including providing an array of two or more electronic enclosures in a side-by-side arrangement within the predetermined width of the equipment rack and removably securing at least two electronic enclosures of the side-by-side arrangement to only a respective one of the mounting members of the electronics equipment rack.

31. A system according to claim 30 wherein each electronic enclosure of the side-by-side arrangement is also removably secured to one or more of the electronic enclosures to which it is arranged alongside.
